(19) United States
(12) Patent Application Publication
(10) Pub. No.: US 2020/0061642 A1
(43) Pub. Date: Feb. 27, 2020

(54) SPREADER

(71) Applicant: GVM, INC., Biglerville, PA (US)

(72) Inventors: Mark W. ANDERSON, Aspers, PA (US); Larry L. HOOVER, Carlisle, PA (US)

(21) Appl. No.: 16/545,392

(22) Filed: Aug. 20, 2019

Related U.S. Application Data
(60) Provisional application No. 62/720,459, filed on Aug. 21, 2018.

(51) Int. Cl. B05B 3/10

(52) U.S. Cl. CPC B05B 3/1057; B05B 9/007

(57) ABSTRACT

A spreader for spreading a material includes a first hopper for receiving a first material, and a pair of first dispensers, each first dispenser of the pair of first dispensers defining a corresponding first spread section for dispensing the first material from the first hopper. A second hopper is selectably receivable in the first hopper, the second hopper for receiving a second material, and a pair of second dispensers, each second dispenser of the pair of second dispensers defining a corresponding second spread section for dispensing the second material from the second hopper. Each second dispenser of the pair of second dispensers is selectively operable independently of each first dispenser of the pair of first dispensers.

### FIELD OF THE INVENTION

The present invention is directed to a spreader utilized to evenly distribute material, and specifically to a spreader attached to a vehicle to distribute granular and/or powdery material.

### BACKGROUND OF THE INVENTION

Farmers, landscapers, and others needing to spread material over large areas need a spreading device that will allow for rapid distribution of the material being spread, covering a large area in an even spread pattern, completed in a reasonably short period of time. The spreading device often determines the success of the operation.

Dual disc centrifugal spreaders are well known in the art. They generally are comprised of flat discs that cast off particulate material in a horizontal plane. A particularly successful dual disc centrifugal spreader is the DOUBLE DUTY spreader available from GVM, Inc. of Biglerville, Pa. and described in U.S. Pat. No. 6,209,808 and pending U.S. application Ser. No. 15/676,248.

There is a need in the art for an improved device that can selectably provide a uniform scatter pattern and throw width of more than one material, either simultaneously, or alternately.

### SUMMARY OF THE INVENTION

In one embodiment, a spreader for spreading a material includes a first hopper having first side walls and first end walls forming a first lateral enclosure for receiving a first material, and a pair of first dispensers, each first dispenser of the pair of first dispensers defining a corresponding first spread section for dispensing the first material from the first hopper. A second hopper is selectably receivable in the first hopper, the second hopper having second side walls and second end walls forming a second lateral enclosure for receiving a second material, and a pair of second dispensers, each second dispenser of the pair of second dispensers defining a corresponding second spread section for dispensing the second material from the second hopper. In preparation of receiving the second hopper in the first hopper, one of the second hopper end walls replaces a corresponding first end wall of the first hopper. Each first dispenser of the pair of first dispensers and each second dispenser of the pair of second dispensers are selectively operable independently of one another.

In another embodiment, a spreader for spreading a material includes a first hopper having first side walls and first end walls forming a first lateral enclosure for receiving a first material, and a pair of first dispensers, each first dispenser of the pair of first dispensers defining a corresponding first spread section for dispensing the first material from the first hopper. A second hopper is selectably receivable in the first hopper, the second hopper having second side walls and second end walls forming a second lateral enclosure for receiving a second material, and a pair of second dispensers, each second dispenser of the pair of second dispensers defining a corresponding second spread section for dispensing the second material from the second hopper. In preparation of receiving the second hopper in the first hopper, one of the second hopper end walls replaces a corresponding first end wall of the first hopper. Each second dispenser of the pair of second dispensers is selectively operable independently of each first dispenser of the pair of first dispensers.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is an upper perspective view of an exemplary spreader with hoppers positioned over the vehicle frame.

FIG. 2 is a lower perspective view of spreader of FIG. 1.

FIG. 3 is an upper perspective view of an optional hopper.

FIG. 4 is a reverse upper perspective view of the hopper of FIG. 3.

FIG. 5 is a lower perspective view of the hopper of FIG. 2.

FIG. 6 is a reverse lower perspective view of the hopper of FIG. 5.

Wherever possible, the same reference numbers will be used throughout the drawings to represent the same parts.

### DETAILED DESCRIPTION OF THE INVENTION

The description of illustrative embodiments according to principles of the present invention is intended to be read in connection with the accompanying drawings, which are to be considered part of the entire written description. Terms such as “attached,” “affixed,” “connected,” “coupled,” “interconnected,” “engaged,” “installed,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

It is to be understood that operating features of the spreader of the present invention are discussed in U.S. Pat. No. 6,209,808 titled “Spreader Attachment” and in pending U.S. application. Ser. No. 15/676,48 titled “Spreader” which is herein incorporated by reference in its entirety.

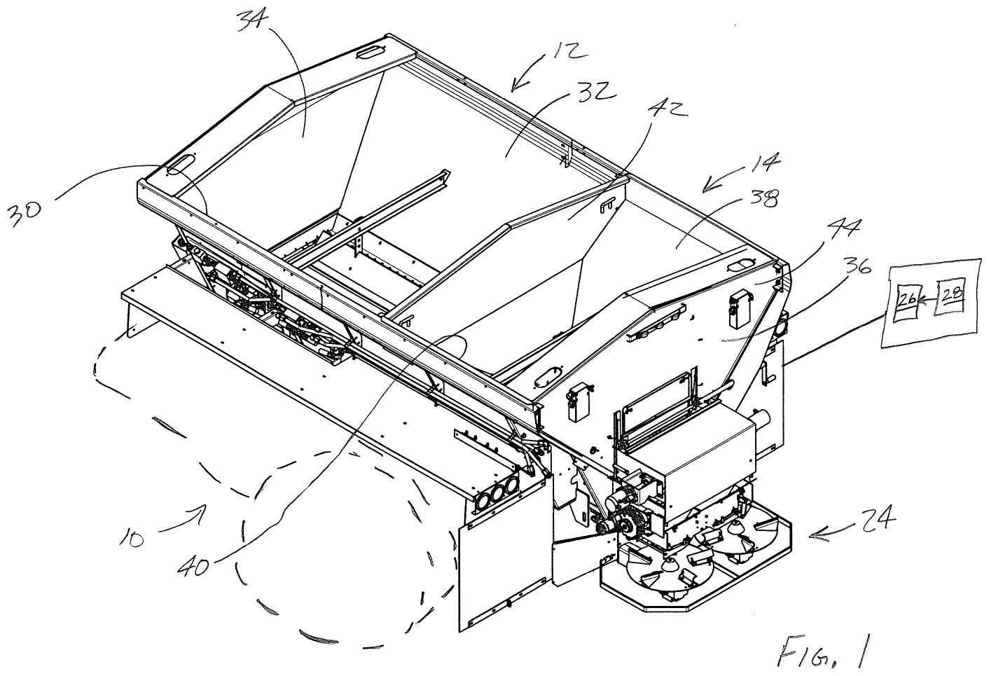

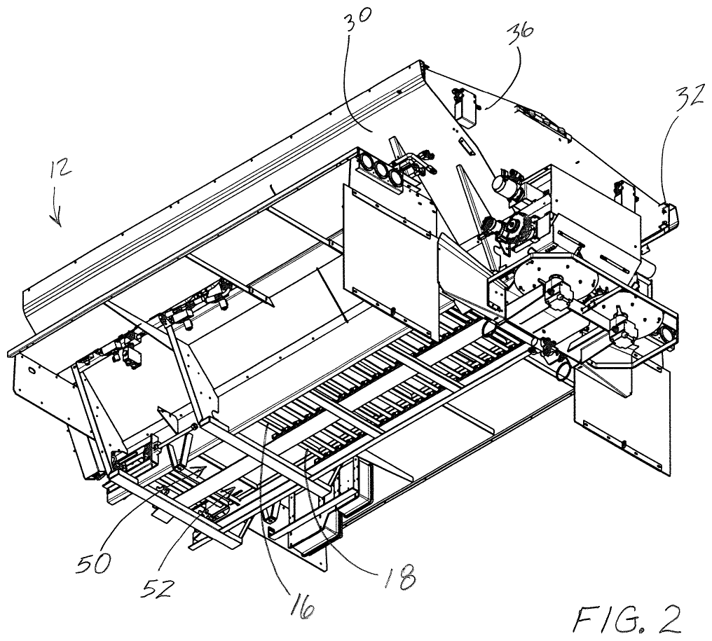

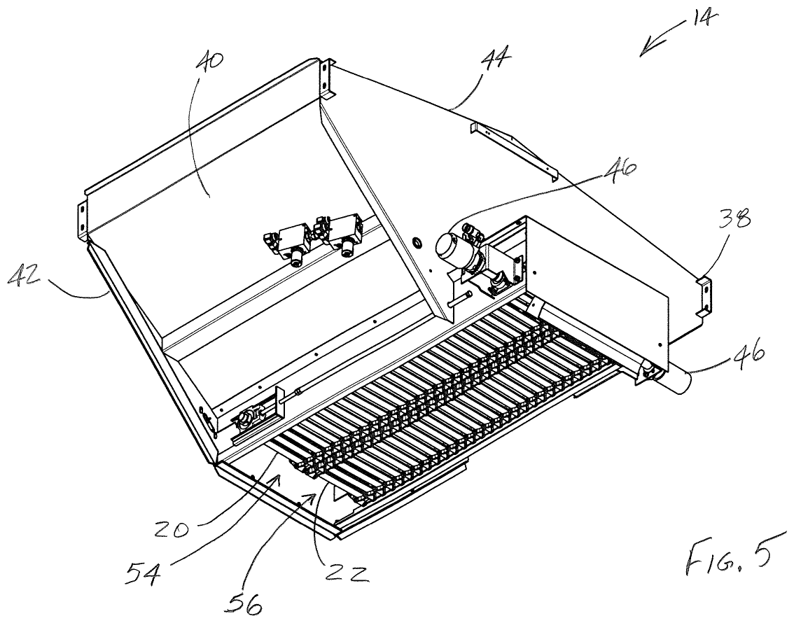

FIG. 1 shows an exemplary spreader 10 of the present invention. Spreader 10 is comprised of a hopper 12 having dispensing devices 16, 18 (FIG. 2), an optional hopper 14 having dispensing devices 20, 22 (FIG. 5) for providing material to a spreader assembly 24. Spreader assembly 24 comprises a pair of corresponding funnel units bladed rotating discs for evenly distributing the material onto a surface. As shown schematically in FIG. 1, the spreader includes a controller 26, such as a computer or microprocessor-based controller. In one embodiment, controller 26 stores information, such as in the form of an electronic map, which is a representation of the area on which material is to be spread. In response to inputting a desired material application per unit area, the required rate of application of the spreadable material is calculated and stored. Controller 26 adjusts the rate of material flow provided to the discs, including independently controlling each of dispensing devices 16 (FIG. 2), 18 (FIG. 2), 20 (FIG. 5), 22 (FIG. 5), as well as other components in order to optimize the scattered pattern of material. Computer control of discs and dispensing devices is well known to those skilled in the art and is not described further herein.

As further shown in FIG. 1, controller 26 receives an input signal from a GPS receiver 28 which provides information as to at least the position of the vehicle, and optionally also the direction and speed of the vehicle. The integration of GPS with controllers is well known to those skilled in the art and is not described further herein.

As shown, each of dispensing devices 16 (FIG. 2), 18 (FIG. 2), 20, (FIG. 5), 22 (FIG. 5) is a continuous belt constructed of suitable flexible material such as rubber or chain with slats, but may be any transport method, for example, a screw type worm. The dispensing devices terminate at a point above a drop box of corresponding funnel units of spreader assembly 24.

As collectively shown in FIGS. 1 and 2, hopper 12 includes side walls 30, 32 and end walls 34, 36, forming a lateral enclosure for temporarily storing material. Hopper 12 includes dispensers or dispensing devices 16, 18 defining corresponding or respective spread sections 50, 52 for providing material to spreader assembly 24, providing improved placement of material compared to spreader constructions utilizing a single dispensing device. Hopper 12 includes a pair of drive motors (not shown) for rotationally driving dispensing devices 16, 18. The drive motors may be hydraulic, electrical, mechanical or other suitable type of drive motor. Hopper 12 is adapted to receive hopper 14. In one embodiment, the material to be distributed in hopper 12 may be different than the material to be distributed in hopper 14. By placing different materials in hoppers 12, 14, only a single pass may be needed, saving time, fuel and wear on the spreader.

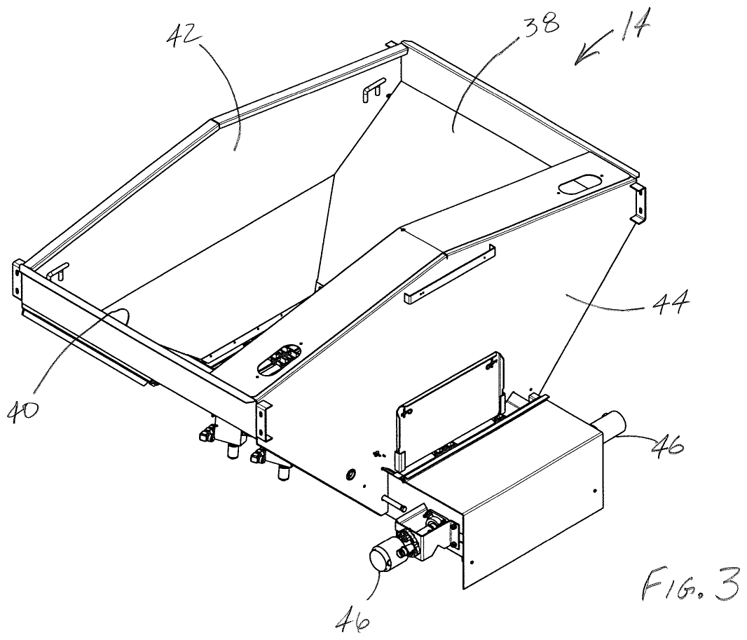

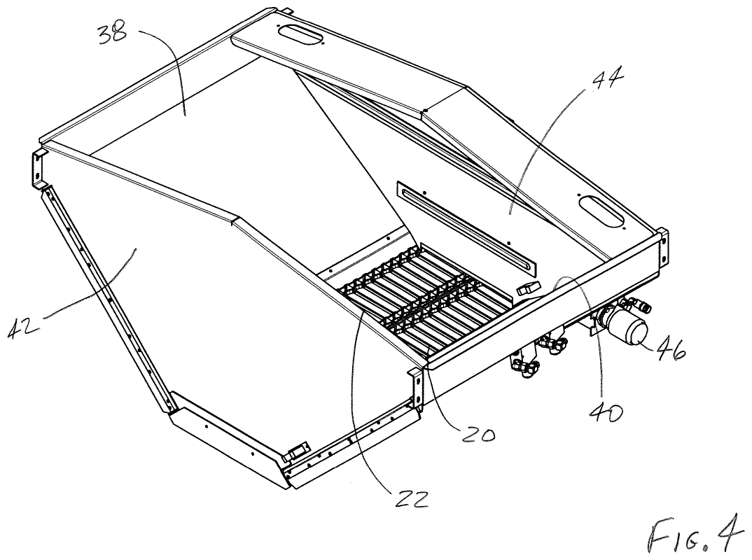

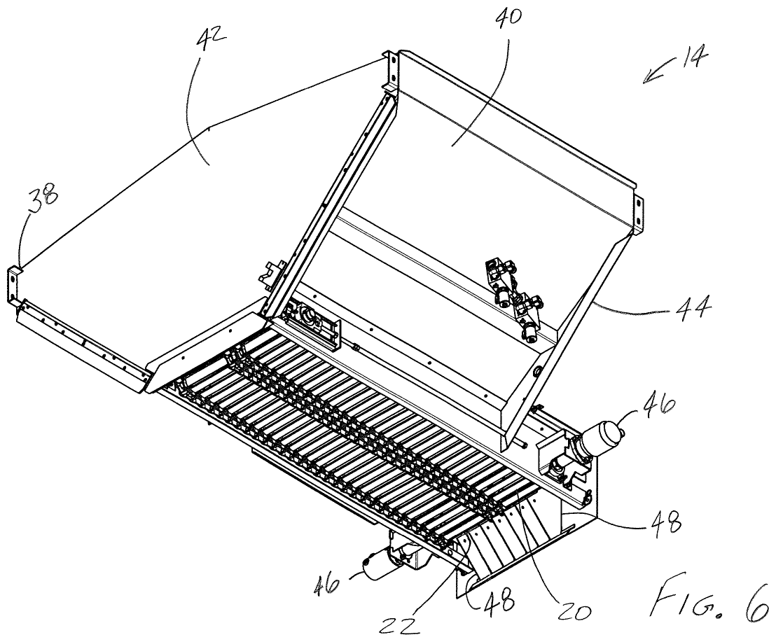

Optionally, as shown in FIGS. 3-6, the spreader 10 (FIG. 1) includes hopper 14 including side walls 38, 40 and end walls 42, 44, forming a lateral enclosure for receiving or temporarily storing material. In one embodiment, end wall 36 of hopper 12 may be removable, such that hopper 14 may be laterally slidably installed in hopper 12, with end wall 44 of hopper 14 serving as the end wall directly facing spreader assembly 24. Side walls 38, 40 of hopper 14 overlie corresponding side walls 30, 32 of hopper 12. Hopper 14 includes dispensers or dispensing devices 20, 22 defining corresponding or respective spread sections 50, 52 positioned vertically above dispensing devices 16, 18 of hopper 12 for providing material to spreader assembly 24, providing improved placement of material compared to spreader constructions utilizing a single dispensing device. Dispensing devices 20, 22 each include a drive motor 46 for rotationally driving dispensing devices 16, 18. The drive motors 46 may be hydraulic, electrical, mechanical or other suitable type of drive motor. Guides 48 help guide material provided by dispensing devices 20, 22 to spreader assembly 24.

In one embodiment, each dispenser 16, 18, 20, 22 is selectively operable independently of one another. In one embodiment, each dispenser 20, 22 is selectively operable independently of dispensers 16, 18. In one embodiment, at least one of dispensers 16, 18 continuously operates during operation of each dispenser 20, 22. That is, in this embodiment, at least one of dispensers 16, 18 must be operating in order for one or both of dispensers 20, 22 to operate.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A spreader for spreading a material comprising:
a first hopper having first side walls and first end walls forming a first lateral enclosure for receiving a first material, and a pair of first dispensers, each first dispenser of the pair of first dispensers defining a corresponding first spread section for dispensing the first material from the first hopper; and
a second hopper selectably receivable in the first hopper, the second hopper having second side walls and second end walls forming a second lateral enclosure for receiving a second material, and a pair of second dispensers, each second dispenser of the pair of second dispensers defining a corresponding second spread section for dispensing the second material from the second hopper;
wherein in preparation of receiving the second hopper in the first hopper, one of the second hopper end walls replaces a corresponding first end wall of the first hopper;
wherein each first dispenser of the pair of first dispensers and each second dispenser of the pair of second dispensers are selectively operable independently of one another.

2. A spreader for spreading a material comprising:
a first hopper having first side walls and first end walls forming a first lateral enclosure for receiving a first material, and a pair of first dispensers, each first dispenser of the pair of first dispensers defining a corresponding first spread section for dispensing the first material from the first hopper; and
a second hopper selectably receivable in the first hopper, the second hopper having second side walls and second end walls forming a second lateral enclosure for receiving a second material, and a pair of second dispensers, each second dispenser of the pair of second dispensers defining a corresponding second spread section for dispensing the second material from the second hopper;
wherein in preparation of receiving the second hopper in the first hopper, one of the second hopper end walls replaces a corresponding first end wall of the first hopper;
wherein each second dispenser of the pair of second dispensers is selectively operable independently of each first dispenser of the pair of first dispensers.

3. The spreader of claim 2, wherein at least one first dispenser of the pair of first dispensers continuously operates during operation of each second dispenser of the pair of second dispensers.
